(19) United States
(12) Patent Application Publication
(10) Pub. No.: US 2011/0143184 A1
(43) Pub. Date: Jun. 16, 2011

(54) BATTERY WITH ELECTROLYTE DIFFUSING SEPARATOR

(75) Inventors: Ellen Mccarthy, Pekin, IL (US); Phil Wiggins, Pekin, IL (US); Kurtis C. Kelley, Washington, IL (US)

(73) Assignee: Firefly International Energy Group, Inc.

(21) Appl. No.: 12/867,667

(22) PCT Filed: Feb. 13, 2009
(86) PCT No.: PCT/US09/34041

§ 371 Date: Feb. 22, 2011

Related U.S. Application Data
(60) Provisional application No. 61/064,076, filed on Feb. 14, 2008.

(51) Int. Cl. H01M 2/18; H01M 2/02

(52) U.S. Cl. 429/145; 429/144; 429/163

(57) ABSTRACT

A separator for use in a battery may include a primary separator layer, wherein the primary separator layer has a peripheral region and an interior region, and wherein the primary separator layer is configured to conduct electrolyte from the peripheral region to the interior region. The separator may also include a secondary separator layer in fluid communication with the primary separator layer, wherein the secondary separator layer includes a material that is less porous than the primary separator layer and wherein the secondary separator layer is configured to receive electrolyte at least from the interior region of the primary separator layer.

This application claims priority to U.S. Provisional Patent Application 61/064,076, filed Feb. 14, 2008.

### TECHNICAL FIELD

This disclosure relates generally to batteries and a battery separator configuration. More particularly, this disclosure relates to a battery including an electrolyte diffusing separator.

### BACKGROUND

Electrochemical batteries, including, for example, lead acid and nickel-based batteries, among others, are known to include at least one positive current collector, at least one negative current collector, and an electrolytic solution. The role of these current collectors is to transfer electric current to and from the battery terminals during the discharging and charging processes. Storage and release of electrical energy in lead acid batteries is enabled by chemical reactions that occur in a chemically active material disposed on the current collectors. The positive and negative current collectors, once coated with this chemically active material, are referred to as positive and negative plates, respectively. Current collectors and battery plates may comprise various materials, including lead plates, carbon foam plates, and graphite plates, among others.

An electrochemical battery may comprise multiple cells. Each cell of a battery may be composed of alternating positive and negative plates. An electrolytic solution may be disposed throughout the battery cell. This electrolyte contacts the positive and negative plates of the battery and allows development of the electrochemical potential of the battery. In certain cases, the electrolytic solution may include a gel.

To reduce the risk of electrical shorts, a battery separator can be used to separate the plates from one another. The battery separator can include an absorbed (or absorbent) glass mat (AGM). Such an AGM, however, can exhibit certain shortcomings. A traditional AGM, whether of a woven or non-woven type, may hinder movement of the electrolyte between the battery plates or within the AGM. As a result, filling the area between the positive and negative plates can be difficult, especially in the case of a gel-electrolyte. For example, because of inadequate or inconsistent porosity, or other diffusion inhibiting factors in the AGM (e.g., fiber size, fiber density, porosity orientation, fiber orientation, and any other characteristics that can affect the flow or diffusion of electrolyte within the AGM), it may be difficult or impossible to saturate the AGM with a gel-electrolyte simply by applying the gel-electrolyte to a periphery of the AGM and allowing the gel-electrolyte to diffuse into an interior region of the AGM. As a result, the gel-electrolyte may be stranded at the edges of the AGM and may be unable to diffuse or flow into the interior region of the AGM. With no electrolyte at the interior region of the AGM, there can be dry areas of adjacent battery plates, especially near the center of the plates, that have little or no contact with the electrolyte. Such uneven distribution of electrolyte can cause a number of problems, including, for example, hot spots in the battery, decreased operating efficiency, and ultimately, product failure.

The amount and orientation of porosity in the AGM can also affect the diffusion rate of gel-electrolyte within the AGM. For example, in the case of low porosity or pore orientations that do not promote diffusion of gel-electrolyte within the AGM, it may take a significant amount of time for the gel-electrolyte to diffuse into the AGM, when complete diffusion is even possible. Such inefficient diffusion can significantly slow the manufacturing process. In addition, an AGM with small pores may have strong capillary attraction to the electrolyte. As a result, the AGM may actually compete with the pore structure of the battery plates for the gel-electrolyte and draw the gel-electrolyte away from the battery plates.

The presently disclosed embodiments are directed to overcoming one or more of these issues.

### SUMMARY

One embodiment of the present invention includes a separator for use in a battery. The separator may include a primary separator layer, wherein the primary separator layer has a peripheral region and an interior region, and wherein the primary separator layer is configured to conduct electrolyte from the peripheral region to the interior region. The separator may also include a secondary separator layer in fluid communication with the primary separator layer, wherein the secondary separator layer includes a material that is less porous than the primary separator layer and wherein the secondary separator layer is configured to receive electrolyte at least from the interior region of the primary separator layer.

Another embodiment of the present invention includes a battery. The battery includes a housing, an electrolytic solution disposed within the housing, at least one cell disposed within the housing, wherein the cell includes a positive plate and a negative plate, and a separator for separating the positive plate and the negative plate, wherein the separator includes a primary separator layer of material with a minimum pore size of at least 16 microns.

It is to be understood that the foregoing general description and the following detailed description are exemplary and explanatory only and are not restrictive of the invention, as claimed.

### BRIEF DESCRIPTION OF THE DRAWINGS

The accompanying drawings, which are incorporated into and constitute a part of this specification, illustrate exemplary embodiments of the invention and, together with the written description, serve to explain the principles of the disclosed embodiments. In the drawings:

FIG. 1 is a diagrammatic perspective view of a battery in accordance with an exemplary disclosed embodiment;

FIG. 2 is a diagrammatic cut-away perspective view of battery cell elements in accordance with an exemplary embodiment disclosed embodiment;

FIG. 3 is a diagrammatic cut-away perspective view of battery cell elements in accordance with an exemplary disclosed embodiment;

FIG. 4 is a diagrammatic cut-away perspective view of battery cell elements in accordance with an exemplary disclosed embodiment;

FIG. 5 is a diagrammatic cut-away perspective view of battery cell elements in accordance with an exemplary disclosed embodiment;

FIG. 6 is a diagrammatic cut-away perspective view of battery cell elements in accordance with an exemplary disclosed embodiment.

### DETAILED DESCRIPTION

Reference will now be made in detail to the exemplary disclosed embodiments, examples of which are illustrated in the accompanying drawings. Wherever possible, the same reference numbers will be used throughout the drawings to refer to the same or like parts.

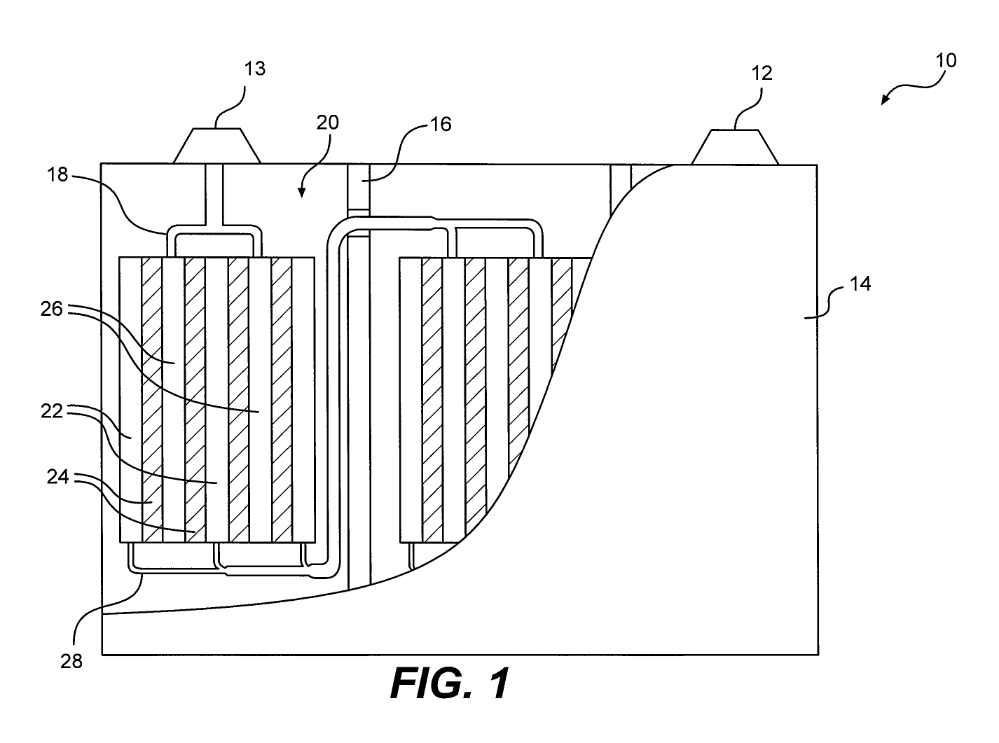

FIG. 1 provides a diagrammatic perspective view representation of a battery 10 in accordance with an exemplary embodiment of the present invention. Battery 10 includes a housing 14, a negative terminal 12, and a positive terminal 13. An electrolytic solution (not shown) may be disposed within housing 14. At least one battery cell 20 is disposed within housing 14. Each battery cell 20 is composed of one or more positive plates 26 alternated with one or more negative plates 22. Positive plates 26 may be separated from negative plates 22 by plate separators 24. While only one battery cell 20 is necessary, battery 10 may include multiple cells, which can be connected either in series or in parallel. Multiple battery cells may be used, for example, to provide a desired total potential of battery 10. In embodiments having multiple cells, each battery cell 20 may be separated from adjacent battery cells by a cell separator 16.

Each battery cell 20 of battery 10 may include current carriers, such as current carriers 18 and current carriers 28 shown in FIG. 1. Current carriers 18 and 28 may be configured in a variety of different ways and may include any of a wide range of materials. For example, in each battery cell 20, all of positive plates 26 may be connected together via current carriers 18 or 28. Alternatively, all of negative plates 22 may be connected together via current carriers 18 or 28. It should be noted, however, that other possible current carrier configurations are possible. For example, in some embodiments of the invention, connections can be made between battery cells. For example, multiple cells of a battery may be connected together in series such that the positive plates of one cell are connected to the negative plates of another cell. Different current carrier configurations for each cell may be more or less appropriate depending on the particular battery application.

An electrolyte can be added to battery such that it at least partially fills a volume between the positive and negative plates of a cell. In some embodiments, the electrolyte may substantially fill the entire volume between the positive and negative plates of a cell.

The electrolyte composition may be chosen to correspond with a particular battery chemistry. In lead acid batteries, for example, the electrolyte may include a solution of sulfuric acid and distilled water. Other acids, however, may be used to form the electrolyte of the disclosed batteries. Batteries of other chemistries may include electrolytes appropriate for the selected chemistry. For example, nickel-based batteries may include an alkaline electrolyte that includes a base (e.g., KOH) mixed with water.

The electrolyte may also include a gel. In one embodiment the gel-electrolyte may include a silica-based gel that includes silica particles in an electrolytic solution. In certain embodiments, for example, silica particles may be added to a solution of sulfuric acid and distilled water in an amount of about 1% to about 8% by weight to form a gel electrolyte. The silica gel-electrolyte of the presently disclosed embodiments may include silica particles having a primary particle size of less than about 1 micron. In certain embodiments, the primary particle size may be between about 15-30 nm. In still other embodiments, the silica particles in the gel-electrolyte may form agglomerates having a size of about 150-200 nm.

Positive plates 26 and negative plates 22 include corresponding current collectors to transfer electric current to and from the battery terminals during the discharging and charging processes associated with battery 10. The current collectors of positive plates 26 and negative plates 22 may include any material suitable for transferring electric current to and from the battery terminals. For example, the positive current collector and the negative current collector may be fabricated from lead, carbon foam, graphite, graphite coated elements, or any other suitable electrically conductive material.

As noted above, plate separators 24 may be disposed between positive plates 26 and negative plates 22 to reduce or eliminate shorting between the plates. In one embodiment, plate separator 24 may include a multi-layer structure including at least a primary separator layer and a secondary separator layer in fluid communication with the primary separator layer. Additional primary and/or secondary separator layers may be included within plate separator 24 without departing from the scope of the invention. In another embodiment, plate separator 24 may include a single layer structure having, for example, a primary separator layer alone.

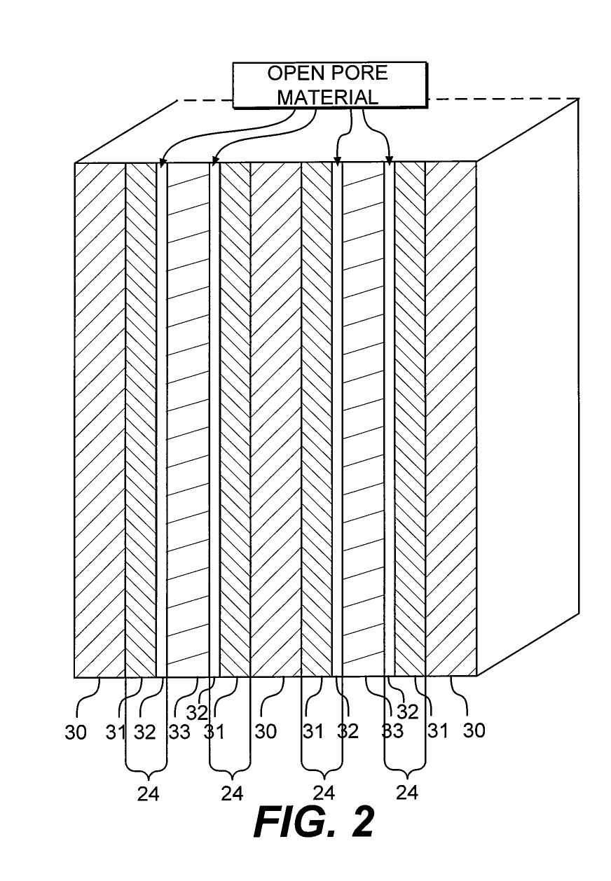

FIG. 2 is a diagrammatic cut-away perspective representation of battery cell elements in accordance with an exemplary disclosed embodiment. As shown, separator 24 may include a two-layered structure to separate positive plates 30 from negative plates 33. The two-layered structure of separator 24 includes a primary separator layer 32 and secondary separator layer 31. In the embodiment shown, separator 24 is configured such that primary separator layer 32 is adjacent to negative plate 33. It is also possible, however, for separator 24 to be configured such that primary separator layer 32 is adjacent to positive plate 30.

Primary separator layer 32 may be configured to facilitate movement of electrolyte into the volume between positive plates 30 and negative plates 33 to improve contact between the electrolyte and the positive and negative plates. For example, primary separator layer 32 may be arranged in fluid communication with secondary separator layer 31, positive plate 30, and/or negative plate 33, and having a structure to encourage the flow or diffusion of electrolyte primary separator layer 32 can increase the amount of electrolyte provided to various regions of secondary separator layer 31, positive plate 30, and/or negative plate 33. By encouraging the transport of electrolyte in this way, primary separator layer 32 can maximize the area of battery plates 30 and 33 that contacts the electrolyte. As a result, and especially in the case of a gel-electrolyte, primary separator layer 32 can significantly reduce or eliminate voided space between positive plate 30 and negative plate 33 having little or no electrolyte present.

Primary separator layer 32 may include one or more channels through which an electrolyte, such as a gel-electrolyte, can flow. Primary separator layer 32 may have a porosity configured to draw in electrolyte material, thereby enabling electrolyte to diffuse, for example, from a peripheral region of primary separator layer 32 to an interior region of primary separator layer 32. As a result, electrolyte may be placed in contact with both the interior region of primary separator layer 32 as well as the peripheral region of the primary separator layer. In one embodiment, primary separator layer 32 may be configured to become at least 80% saturated with gel-electrolyte material upon exposure of the primary separator layer to the gel-electrolyte.

Primary separator layer 32 can include any configuration suitable for facilitating diffusion of the electrolyte to an interior region of the primary separator layer. Primary separator layer 32 may include woven or non-woven materials. Primary separator layer 32 may also be configured with a minimum pore size. For example, in one embodiment, primary separator layer 32 may have a minimum pore size of at least 16 microns. In another embodiment, primary separator layer 32 may have a minimum pore size of at least 50 microns. Primary separator layer 32 may also be configured according to the particular type of electrolyte to be used in battery 10. For example, in one embodiment, primary separator layer 32 may be configured to have a minimum pore size of about 80 times the maximum average particle size included in a gel-electrolyte.

Primary separator layer 32 can include any material appropriate for contact with the electrolyte of battery 10. For example, primary separator layer 32 may include woven or non-woven glass fibers. Primary separator layer 32 can also be fabricated using materials similar to those used in roofing applications. Such materials may include glass fibers of varying lengths (e.g., about 1 centimeter, several centimeters, or more) bonded together with an acrylic latex. In another embodiment, primary separator layer 32 may include a woven polyethylene screen. In certain embodiments, such a screen may include fibers of at least 10 centimeters in length. Additionally or alternatively, primary separator layer 32 may include other materials such as acid resistant plastics, polycarbonates, natural rubber, polyolefins, various polymer compounds, and/or any other suitable material.

Primary separator layer 32 may be dimensioned in accordance with any particular battery application. For example, primary separator layer 32 may be configured to have substantially the same length and width as adjacent battery plates. Alternatively, primary separator layer 32 may be configured to be longer and/or wider than the adjacent battery plates. For example, in one embodiment, the battery plates may be approximately 150 mm×150 mm, and primary separator layer 32 may have similar length and width. Primary separator layer 32 may also include any suitable thickness dependent on a particular application. In one embodiment, primary separator layer 32 may have a thickness in a range of about 0.1 mm to about 0.5 mm. In another embodiment, primary separator layer 32 may have a thickness of about 0.2 mm.

In addition to primary separator layer 32, separator 24 may also include at least one secondary separator layer 31, as shown in FIG. 2. Secondary separator layer 31 is less porous than primary separator layer 32. That is, secondary separator layer 31 may have smaller and/or fewer pores than primary separator layer 32. Secondary separator layer 31 may be in fluid communication with primary separator layer 32 and may be configured to receive electrolyte from primary separator layer 32, such that secondary layer 31 receives electrolyte over substantially its entire area. In certain embodiments, secondary separator layer 31 may receive electrolyte material at least from an interior region of the primary separator layer. Such fluid communication between the primary and secondary separator layers can encourage effective transport of electrolyte within separator 24 and, in turn, between positive plates 30 and negative plates 33.

Secondary separator layer 31 may include any suitable material. In one embodiment, second separator layer 31 may include an absorbed (or absorbent) glass mat (AGM). Other non-conductive woven and non-woven materials (e.g., various polymers) may be used. In addition, secondary separator layer 31 may be configured to have any suitable thickness appropriate to meet the needs of a particular application.

Primary separator layer 32 can significantly improve electrolyte saturation of a battery cell. For example, upon filling a battery cell with a gel-electrolyte, primary separator layer 32 can efficiently conduct the gel-electrolyte from its peripheral region to its interior region. Through this conduction ability, primary separator layer 32 may be substantially saturated with the gel-electrolyte.

Because the primary separator layer is positioned into fluid communication with the secondary separator layer, gel-electrolyte may diffuse from the primary separator layer to the secondary separator layer. That is, the secondary separator layer may receive gel-electrolyte at least from the interior region of the primary separator layer. The electrolyte conduction ability of the primary separator layer may increase the speed and effectiveness by which a secondary separator layer, in contact with the primary separator layer, becomes saturated with electrolyte.

Additionally, primary separator layer 32 can encourage retention of electrolyte within adjacent battery plates. For example, because of its increased pore size and/or porosity level, primary separator layer 32 may exhibit less capillary attraction to the electrolyte than, for example a traditional AGM. Therefore, primary separator layer 32 may compete less with the battery plate pore structure for electrolyte and may promote retention of electrolyte within the battery plate pore structure.

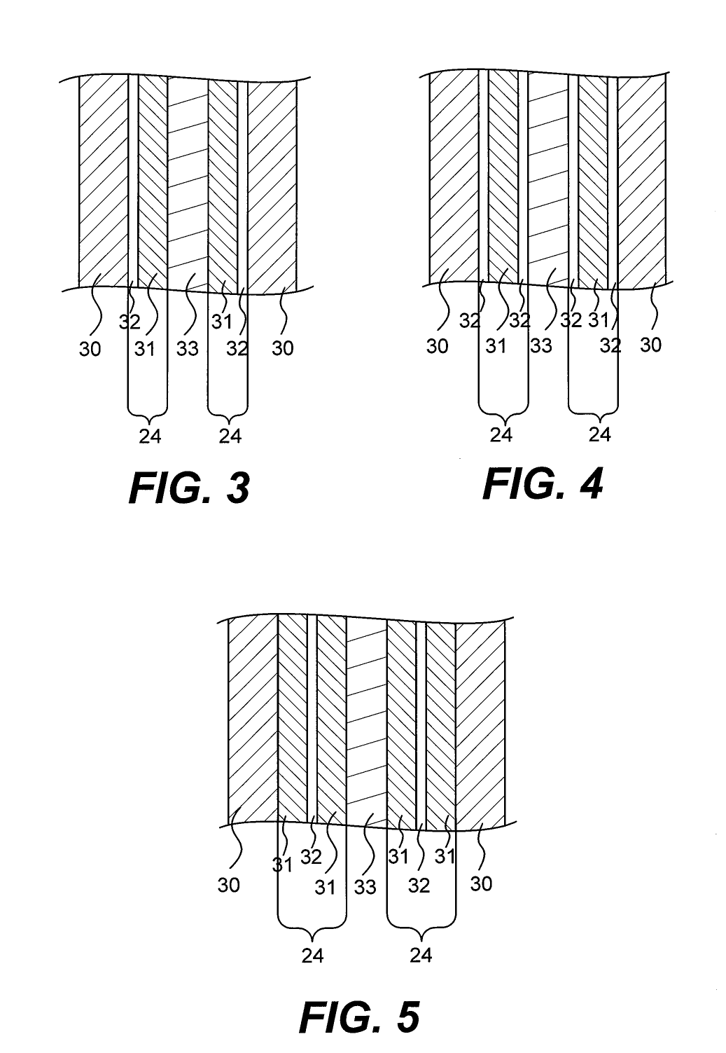

In addition to the embodiments described above, several other arrangements of separator 24 within battery cell 20 are possible. For example, as illustrated in FIG. 3, a two-layer separator 24 can be used to separate positive plate 30 and negative plate 33. In this embodiment, separator 24 includes a primary separator layer 32 and a secondary separator layer 31 arranged such that secondary separator layer 31 is adjacent to negative plate 33.

FIG. 4 shows another exemplary embodiment in which separator 24 includes a three-layer structure to separate positive plate 30 and a negative plate 33. In this embodiment, separator 24 includes two primary separator layers 32 that together sandwich a secondary separator layer 31. Further, separator 24 is configured such that primary separator layers 32 are adjacent to both positive plate 30 and negative plate 33.

FIG. 5 shows another exemplary embodiment in which separator 24 includes a three-layer structure to separate positive plate 30 and a negative plate 33. In this embodiment, separator 24 includes two secondary separator layers 31 that together sandwich a primary separator layer 32. Further, separator 24 is configured such that secondary separator layers 31 are adjacent to both positive plate 30 and negative plate 33.

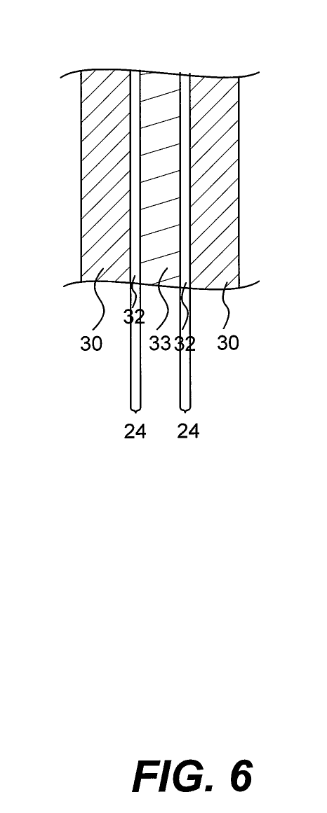

FIG. 6 shows yet another exemplary embodiment in which separator 24 includes only a single layer of material. In this embodiment, separator 24 includes only a primary separator layer 32.

The presently disclosed embodiments offer several potential advantages over traditional configurations. For example, the use of gel-electrolytes can minimize the risk of battery plates drying out, especially those with large pores and relatively little capillary action. As a result, gel-electrolytes may increase the life and performance of a battery.

Moreover, using a primary separator layer, as described above, can improve battery life and performance. The primary separator layer may increase electrolyte saturation of the separator structure and, therefore, result in more consistent distribution of electrolytes, especially gel-electrolytes, within the cells of a battery. Improved saturation of gel-electrolyte throughout the battery may lead to longer cycle life, increased capacity, and protection from effects of over voltage charging, among other benefits. Testing performed on configurations similar to those of the presently disclosed embodiments has shown, on average, an approximate 15% increase in battery capacity. The primary separator layer can also help minimize or eliminate hot spots within the battery cell by promoting more efficient and complete electrolyte saturation of the separator structure, which may permit the battery to operate more uniformly across its plate structures.

The presently disclosed separator structure may also significantly decrease the time needed to fill a battery with electrolyte.

It will be apparent to those skilled in the art from consideration of the specification and practice of the invention disclosed herein that various modifications and variations can be made in the system of the present invention. Therefore, the invention in its broader aspects is not limited to the specific details and illustrative examples shown and described in the specification. It is intended that departures may be made from such details without departing from the true spirit or scope of the general inventive concept as defined by the following claims and their equivalents.

We claim:

1. A separator for use in a battery, comprising:
a primary separator layer, wherein the primary separator layer has a peripheral region and an interior region, and wherein the primary separator layer is configured to conduct electrolyte from the peripheral region to the interior region; and
a secondary separator layer in fluid communication with the primary separator layer, wherein the secondary separator layer comprises a material that is less porous than the primary separator layer, and wherein the secondary separator layer is configured to receive electrolyte at least from the interior region of the primary separator layer.

2. The separator of claim 1, wherein the secondary separator layer includes an absorbed glass mat (AGM).

3. The separator of claim 1, wherein the electrolyte includes a gel-electrolyte.

4. The separator of claim 3, wherein the gel-electrolyte is a silica-based gel having primary particles of at least 15 nm in size, and having average agglomerates of about 150-200 nm.

5. The separator of claim 1, wherein the primary separator layer has a minimum pore size of at least about 16 microns.

6. The separator of claim 1, wherein the primary separator layer has a minimum pore size of at least about 50 microns.

7. The separator of claim 1, wherein the primary separator layer comprises a non-woven glass fiber material.

8. The separator of claim 3, wherein the primary separator layer is configured to become at least 80% saturated with the gel-electrolyte when exposed to the gel-electrolyte.

9. A battery, comprising:
a housing;
an electrolytic solution disposed within the housing;
at least one cell disposed within the housing, wherein the cell comprises a positive plate and a negative plate; and
a separator for separating the positive plate and the negative plate, wherein the separator comprises a primary separator layer of material with a minimum pore size of at least about 16 microns.

10. The battery of claim 9, wherein the primary separator layer has a peripheral region and an interior region, and wherein primary separator layer is configured to conduct electrolyte from the peripheral region to the interior region, and wherein the separator further comprises:
a secondary separator layer comprising a material which is less porous than the primary separator layer, wherein the secondary separator layer is adjacent and in fluid communication with the primary separator layer, and wherein the secondary separator layer is configured to receive electrolyte at least from the interior region of the primary separator layer.

11. The battery of claim 10, wherein the secondary separator layer includes an absorbed glass mat (AGM).

12. The battery of claim 9, wherein the electrolytic solution includes a gel-electrolyte.

13. The battery of claim 12, wherein the gel-electrolyte is a silica-based gel having primary particles of at least 15 nm in size, and having average agglomerates of about 150-200 nm.

14. The battery of claim 13, wherein the primary separator layer has a minimum pore size of about 80 times the maximum average particle size included in a gel-electrolyte

15. The battery of claim 10, wherein the primary separator layer comprises a non-woven glass fiber material.

16. The battery of claim 12, wherein the primary separator layer is configured to become at least 80% saturated with the gel-electrolyte when exposed to the gel-electrolyte.

17. The battery of claim 10, wherein the separator further includes a third layer of substantially the same material as the primary separator layer located adjacent to a side of the secondary separator layer opposite from a side of the secondary separator layer adjacent to the primary separator layer.

18. The battery of claim 10, wherein the separator further includes a third layer of substantially the same material as the secondary separator layer located adjacent to a side of the primary separator layer opposite from a side of the primary separator layer adjacent to the secondary separator layer.
